(19) United States
(12) Patent Application Publication
(10) Pub. No.: US 2012/0089275 A1
(43) Pub. Date: Apr. 12, 2012

(54) SIMULATION TRANSMITTER FOR REMOTE OPERATED VEHICLES

(76) Inventors: Lee Yao-Chang, Puzih City (TW); Huang Yu-Chien, Taipei City (TW)

(21) Appl. No.: 13/269,083

(22) Filed: Oct. 7, 2011

Related U.S. Application Data
(60) Provisional application No. 61/391,008, filed on Oct. 7, 2010.

(51) Int. Cl. G06F 17/00

(52) U.S. Cl. 701/2

(57) ABSTRACT

A simulation transmitter for remote operated vehicles (STROV) is disclosed for allowing users in the toy and hobby industry to realistically simulate, everyday driving experiences and implement them into any remote-controlled vehicle. The STROV system remotely operates land, air and sea remote controlled hobby vehicles, boats and planes. It includes a steering wheel, a separate hand-operated throttle and brake control and a separate foot-operated throttle and brake control.

### CROSS REFERENCE

The present application claims priority to U.S. Provisional Patent Application No. 61/391,008 filed on Oct. 7, 2010, which is hereby incorporated by reference in its entirety.

### BACKGROUND OF THE INVENTION

Remote-controlled vehicles are common and have achieved a measure of significant commercial success. Traditionally, remote-controlled vehicles are those in which the steering functions and the forward or reverse drive functions are controlled by radio from a hand-held unit. Remote-controlled units are those in which a hand-held control unit is connected to the vehicle by a flexible tether. In each instance, the user manipulates a joy stick or other control means to vary the steering of the vehicle and cause the vehicle to move forward, rearward or remain stationary.

Traditionally, a typical remote-controlled model vehicle includes a wheeled vehicle having a motor and steering mechanism which engages the wheels. A transmitter which is typically held by a person controlling the vehicle broadcasts control signals to a vehicle-mounted receiver which controls the motor and steering mechanism of the vehicle to facilitate forward, rearward and steering motions of the vehicle. Furthermore, traditional remote controllers utilize a piston grip type hand held unit which has a trigger for throttle and a vertical approximately 2 inch steering wheel that is used with one hand for controlling. Although this design has been effective for many years, it is very un-conventional and new consumers cannot relate to this control system.

Given the above deficiencies in the prior art, there is a need for a more advanced remote transmitter system that can simulate driving of an actual vehicle while driving a remote controlled vehicle.

### SUMMARY OF THE INVENTION

In one embodiment, the present invention provides a simulation transmitter for driving a recreational vehicle that simulates driving of a non-recreational vehicle, comprising: a) a first transmitter and a first receiver connected to a first central processing unit adapted to exchange transmission signals with at least one remote controlled vehicle having a second transmitter and a second receiver connected to a second central processing unit, said vehicle optionally having a vibration sensor; b)a steering mechanism (preferably a realistic mechanism depending on the vehicle) or a port for removably attaching said mechanism; c) a throttle or a port for removably attaching a throttle; d) a screen or a port for removably attaching a screen to monitor the vehicle; and e) an optional vibrator or a port for removably attaching a vibrator; wherein the simulation transmitter with the screen and the throttle through real time communication with the remote controlled vehicle provide a driving experience that simulates driving of a non-recreational vehicle that the recreational vehicle is designed after; wherein if the vibration sensor detector and vibrator are present, a driver receives a vibration feedback depending on the movement of the vehicle. The simulation can be carried out by providing realistic steering, preferably realistic throttle, preferably realistic braking, real time screen that displays information as a non-recreation vehicle would do, and vibration alerts as to provide a constant feedback on movement of the vehicle to the driver. The screen can be a digital LCD or LED screen. A brake can engage when the driver moves the throttle control in opposite direction of acceleration. The transmitter is used in conjunction with a separate hand-operated or foot-operated throttle control that is attached through the port. The vibration sensor can detect one or more of hard landing (landing on less than all wheels), uneven terrain, bumpy terrain, rough terrain or bumping into another object or a structure. The simulation transmitter of claim 1, wherein the screen displays in real time one or more of the following information: a) speed; b) on board engine temperature; c)fuel tank level; d) vehicle battery voltage level; e) radio battery voltage level; f) lap time; g) stop watch; h) vibration alerts; i)altitude if the vehicle flies; and j) altitude if the vehicle travels under water. The screen can be lit for night vision with a plurality screen colors and tones. The screen can have physical gauges. The remote controlled vehicle can have an electric engine/motor for moving the vehicle and the screen displays at least 3, 4 or 5 or more of the following in any combination: a) speed; b) engine temperature; c) battery voltage level for the vehicle; d) simulation transmitter's battery voltage levels; e) RPM gauge with a warning indicator; f) lap times. The remote controlled vehicle can have an engine/motor that uses fuel and the screen displays at least 3, 4, 5, 6, or more of the following in any combination: a) speed; b) engine temperature; c) fuel level; d) battery voltage level for the vehicle; e) simulation transmitter's battery voltage levels; f) RPM gauge with a warning indicator; g) oil pressure; and h) water temperature. The simulation transmitter learns a track layout, and then calculates lap time and records the driven course for each lap, and displays course map or lap times on the screen. A plug and play technology can be used to display and transfer video output and data via the port on a computer screen, monitor or television, resulting in the computer screen, monitor or television acting as the screen of the simulation transmitter. The vehicle can be a remote controlled vehicle is a car, truck, buggy, off-road vehicles. The vehicle can be a flying airplane, helicopter, UFO or flying saucer. The vehicle can be a boat, submarine, or jet ski. The vehicle can have an on-board battery with sufficient capacity to allow for supplementary applications selected from the group consisting of at least one of a glow igniter charger, a battery charger, a battery balancer, and a battery discharger, and combinations thereof. The driver can sit in a fixed position to operate the remote controlled vehicle in front of a screen. The ignition can be with a real key.

In one embodiment, the present invention provides a remote controlled vehicle system for driving a recreational vehicle that simulates driving of a non-recreational vehicle, comprising: a) at least one remote controlled vehicle with a transmitter and a receiver connected to a central processing unit, said vehicle optionally having a vibration sensor; b) a simulation transmitter having: (i) a transmitter and a receiver connected to a central processing unit adapted to exchange transmission signals with the remote controlled vehicle; (ii) a steering mechanism (preferably realistic) or a port for removably attaching said mechanism; (iii) a throttle or a port for removably attaching a throttle to monitor the vehicle; (iv) a digital screen or a port for removably attaching a digital screen; and (v) an optional vibrator or a port for removably attaching a vibrator; wherein the simulation transmitter with the screen and the throttle through real time communication with the remote controlled vehicle provide a driving experience that simulates driving of a non-recreational vehicle that the recreational vehicle is designed after; wherein if the vibration sensor detector and vibrator are present, a driver receives a vibration feedback depending on the movement of the vehicle.

### BRIEF DESCRIPTION OF THE DRAWINGS

FIG. 1 illustrates the top view of the steering wheel, which allows the user to operate the throttle and brake control with their finger.

FIG. 2 illustrates the separate throttle and brake control system, which can be operated by the users' hand.

FIG. 3 illustrates the attachable pedal and throttle/brake system, which can be operated by the users' foot.

FIG. 4 illustrates the STROV airplane style handle controller designed for remote controlled airplanes and helicopters. It also contains an attachable pedal and throttle/brake system, which can be operated by the users' foot.

FIG. 5 illustrates the user sitting in a fixed position, such as on a chair, operating the STROV steering wheel in front of a screen. The screen overcomes the limited perspective offered by traditional systems.

FIG. 6 illustrates the back view of the STROV steering wheel.

FIG. 7 illustrates a way that STROV can be secured by means of two clamps.

FIG. 8 illustrates a way that STROV can be secured by a chair and a stand.

FIG. 9 illustrates a way that STROV can be secured by a portable pole dropped down from the STROV itself.

FIG. 10 illustrates the ignition key switch with a key in place.

FIG. 11 illustrates the ignition key switch with no key in place.

FIG. 12 illustrates the engine RPM (revolutions per minute) gauge with warning indicator.

FIG. 13 illustrates the engine temperature gauge with warning indicator.

FIG. 14 illustrates the LCD screen for use with the STROV.

FIG. 15 illustrates the vehicle with a servos motor for steering the vehicle and a receiver/transmitter that is in communication with the STROV.

FIG. 16 illustrates a course map generated by the STROV system, and monitoring of lap times and subsequent courses.

FIG. 17 illustrates a screen that displays information about the battery voltage, engine RPM, oil pressure, engine oil temperature, speed or water temperature

FIG. 18 illustrates a vehicle travelling over uneven terrain

FIG. 19 illustrates a vehicle travelling over bumpy terrain

FIG. 20 illustrates a STROV with different input ports to plug in various equipment.

FIG. 21 illustrates one embodiment of an electronic map of a vehicle.

FIG. 22 illustrates one embodiment of an electronic map of the STROV.

FIG. 23 illustrates the interaction between the vehicle and the STROV to map a course for the vehicle.

FIG. 24 illustrates a hard landing that would trigger the vibrator sensor.

### DETAILED DESCRIPTION OF THE PREFERRED EMBODIMENT(S)

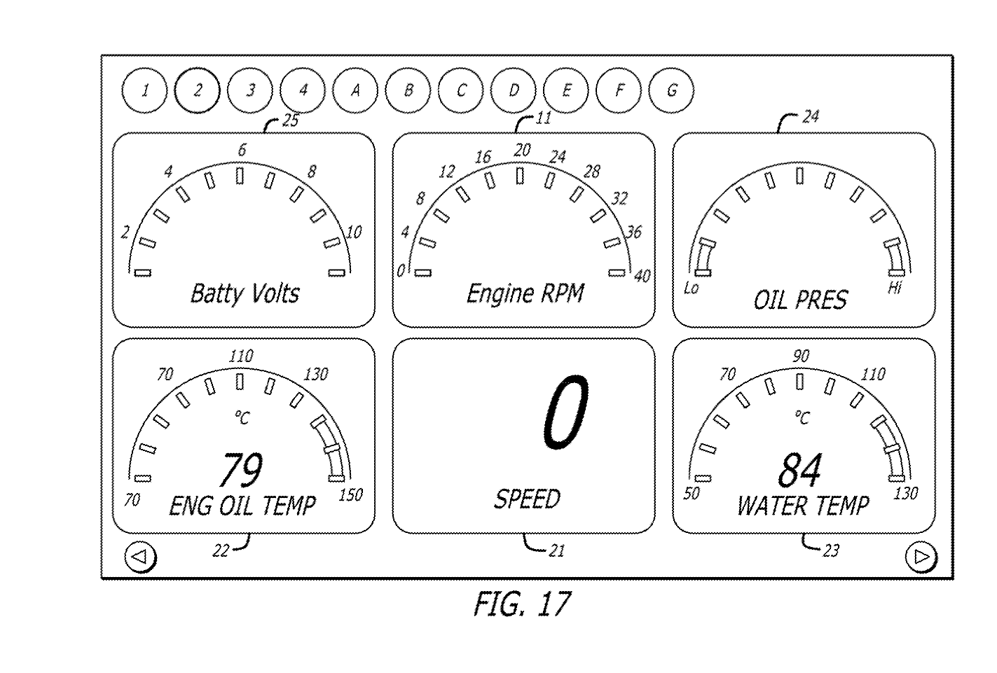

The present invention provides a simulation transmitter for remote operated vehicles (STROV). The present invention captures everyday driving skills and implementing them into any remote control vehicle. The consumer can have the opportunity to experience a realistic driving experience unlike any other within the hobby industry, thereby heightening the fun and securing their interest within the hobby itself right down to turning on the system with an ignition, for example by utilizing an actual key. By realistic it is meant that it simulates the actual vehicle that the recreational vehicle is designed after. For example, if the recreational vehicle is an automobile, the STROV simulates driving of an actual automobile. A realistic steering mechanism for an automobile for example would be a steering wheel. A realistic display for an automobile is shown in FIG. 17. An ideal simulation would have all the realistic features for a vehicle. The STROV, however, can provide a realistic experience without all the features. For example, for an automobile, a realistic steering wheel, display, and vibration feedback may be sufficient with use of hand operated versus foot operated throttle/brake.

The STROV system simulates driving of an actual vehicle so a user has the experience of driving an actual non-recreational vehicle. This simulation can be done in different manners. A realistic steering wheel (1) and throttle (2, 3) either come attached with the STROV or the STROV provides a plug for removable attaching (so be in electronic communication) them that allow a user to maneuver the vehicle as is the vehicle is an actual vehicle. The vehicle can also have a brake system (reversing the throttle) that is controlled An actual key (8a, 8b) can be used to start the STROV, further providing a realistic experience. The screen (5) can further provide real time (less than one minute, preferably less than 10 seconds, more preferably substantially instantaneously) information about the vehicle in much more detail than presently available. The screen (5) for example can provide the information that is displayed on an actual vehicle. A realistic display of information is shown in FIG. 17. The vibration alerts further provide feedback on the terrain so a user feels as if driving an actual vehicle. If the road is not smooth, for example it has bumps, the driver of the vehicle feels the bumps and other characteristics of the terrain. There is also feedback for hard landings and crashes. The STROV also tracks the vehicle and provide a course map. Each time the vehicle completes a lap, the STROV shows the route traveled in relation to previous laps and lap times.

The STROV system is unique and has realistic steering wheel (1) and throttle (2,3) control physical capabilities. The steering wheel (1) can induce realistic vibrations and feedback based on the terrain. This information is sent from vehicle to radio via the bandwidth and on board sensors within the vehicle (force feedback). This allows the users to experience realistic off-road or on-road racing on a much more affordable budget.

The STROV system's main console utilizes built-in connections to adapt and install various accessory applications ranging from lap counters, engine temperature gauge, battery levels , timers, a driver to pit man communication device, vibration alerts, ring tones, and much more all of which are displayed on the console's main LCD (5) display. The accessory applications can be available separately as a standalone unit. For example, the gauge may be plugged into the console for charging but it is also capable of working as a standalone unit. Furthermore, the readings off of these accessories are viewable both on the console and on the accessories themselves.

The STROV system does not limit itself in its applications. For example, the steering wheel (1) can be removed and replaced with other styles to cope with the user's application. In one embodiment, a realistic fully functional yoke (FIG. 4) can be added on to experience a simulated flight experience. In another embodiment, a traditional helm (boat steering wheel) can be added on for a true boat sailing experience.

The present STROV system also allows the user to use an attachable pedal (3) and brake system in one embodiment that can be operated by the users' foot just like a real driving experience.

The present STROV system also can utilize a novice learning software program, which learns the track layout while the user drives through the course for the first time. Subsequently, it can then perform lap by lap, turn by turn, comparison along with full session lap times (19) and total laps. The user can utilize this program to improve their performance skills (20).

The present STROV system also works through various bandwidths and frequencies that have been dedicated to the hobby industry. These bandwidths may include, but are not limited to AM, FM 27 MHz, 75 MHz, 40 MHz, and 2.4 GHz, to all of which have varying frequencies. Within the STROV system, there are limitless channels to power the many variations of hobby controlled boats, planes, and vehicles.

For surface vehicles and boats, the STROV system can be capable of a very wide range of data output to the user. The STROV digital screen (5) can display and monitor a wide variety of information. This information may include, but is not limited to real time on board, engine temperature (22), fuel tank levels (26), battery voltage levels (25), radio battery voltage levels, lap times (28), stop watch capabilities, vibration alerts, lit screen for night vision with various screen colors and tones, land speed (21) based on an onboard wheel rotation monitor system.

The STROV can utilize plug and play technology to display and transfer video output and data on any computer screen/monitor. Included software can allow the user to apply desired adjustments on their Personal computer, laptop or electronics.

For air and flight vessels, the STROV system can allow for a traditional flight control to be installed to replace the traditional steering wheel (FIG. 4). The flight control can simulate the controls of flying an airplane. The existing capabilities listed above can also apply during the use of the flight attachment.

The STROV system can utilize a high capacity on-board battery enough to allow for supplementary applications such as a glow igniter charger, battery charger, battery balancer, battery discharger, all with digital read outs and adjustable amperage. The STROV system can be charged by plugging it into any power source.

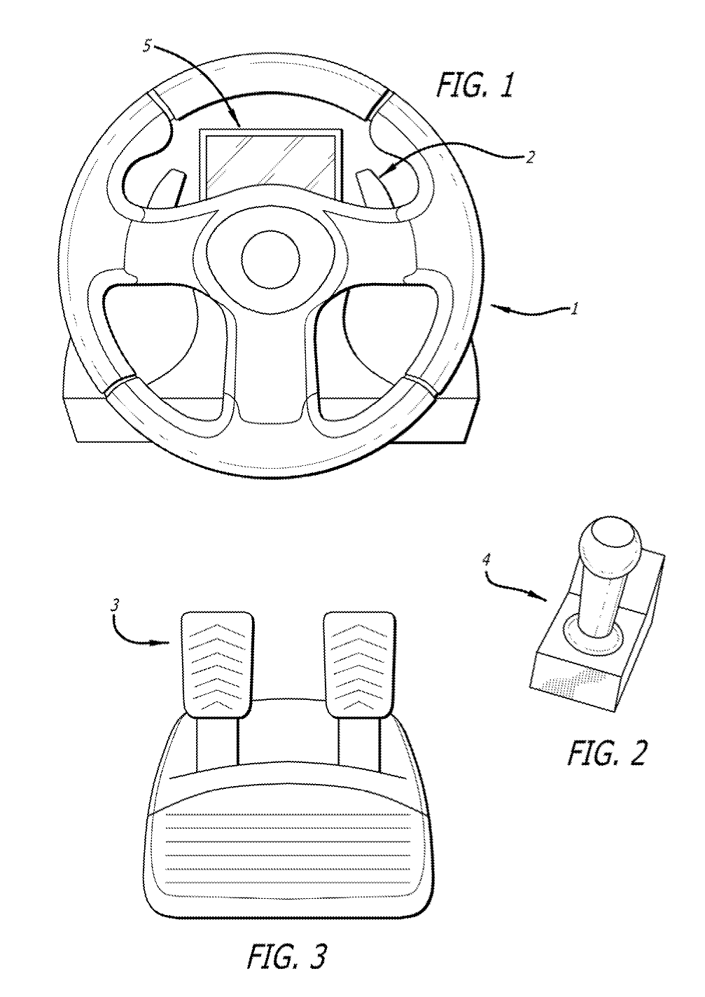

Referring now to FIG. 1, the STROV steering wheel (1) is depicted with steering control (1), the throttle (2) and brake control (2) that the user can control with their finger, and a digital LCD screen (5).

The realistic steering wheel (1) and throttle (2, 3) control physical capabilities are illustrated. The steering wheel (1) allows the user to experience realistic vibrations and feedback based on the terrain. This information is sent from vehicle to radio via the bandwidth and on board sensors within the vehicle (force feedback). This can provide the users with the opportunity to experience realistic off-road or on-road racing on a much more affordable budget.

A user can also utilize the throttle/brake control (2,3) with their finger while gripping the steering wheel (1) at the same time. In one embodiment, the steering wheel has a diameter of least about 4 inches, or about 5 inches, or about 7 inches.

The screen (5) provided by the STROV systems allows users to view the racetrack or other' surface from the vantage point of the remote-controlled vehicle, which enhances their experience of operating the vehicle. This overcomes the limited perspective offered by traditional systems. The vehicle can have a camera to transmit the course on a screen for the driver. Alternatively, the driver while in a sitting position has visual contact with the vehicle and relies on the screen for information about the vehicle.

The STROV digital LCD (5) or LED screen or a screen with physical gauges can display and monitor the following information; real time on board engine temperature (22), fuel tank levels (26), battery voltage levels (25), radio battery voltage levels, lap times (28), stop watch capabilities, vibration alerts (32), lit screen for night vision with various screen colors and tones, land speed (21) based on an onboard wheel (1) rotation monitor system.

A novice learning software program can be used to learn the track layout while the user drives through the course for the first time. This learning program can perform lap by lap, turn by turn, comparison along with full session lap times and total laps. The user can utilize this program to improve their performance skills.

The STROV system can utilize plug and play technology to display and transfer video output and data on any computer screen or monitor. Included software can allow the user to apply desired adjustments on their PC or laptop.

The steering wheel (1) can be removed and replaced with other styles to cope with the user's application. In one embodiment, a realistic fully functional yoke can be added on to experience a simulated flight experience. In another embodiment, a traditional helm (boat steering wheel) can be added on for a true boat sailing experience.

The STROV system can allow for a traditional flight control to be installed, thereby replacing the traditional steering wheel for air and flight vessels. The flight control can simulate the controls of flying an airplane. The existing capabilities listed above can also apply during the use of the flight attachment.

The STROV system can utilize a high capacity on-board battery enough to allow for supplementary applications such as a glow igniter charger, battery charger, battery balancer, battery discharger, all with digital read outs and adjustable amperage. The STROV system can be charged by plugging it into any power source.

In an embodiment, the ignition of the STROV system utilizes an actual key.

FIG. 1 illustrates a STROV system with a steering wheel (1), hand operated throttle (2) and a screen (5). A driver can steer with the stirring wheel and move the vehicle with the throttle. The screen would display real time information about the vehicle.

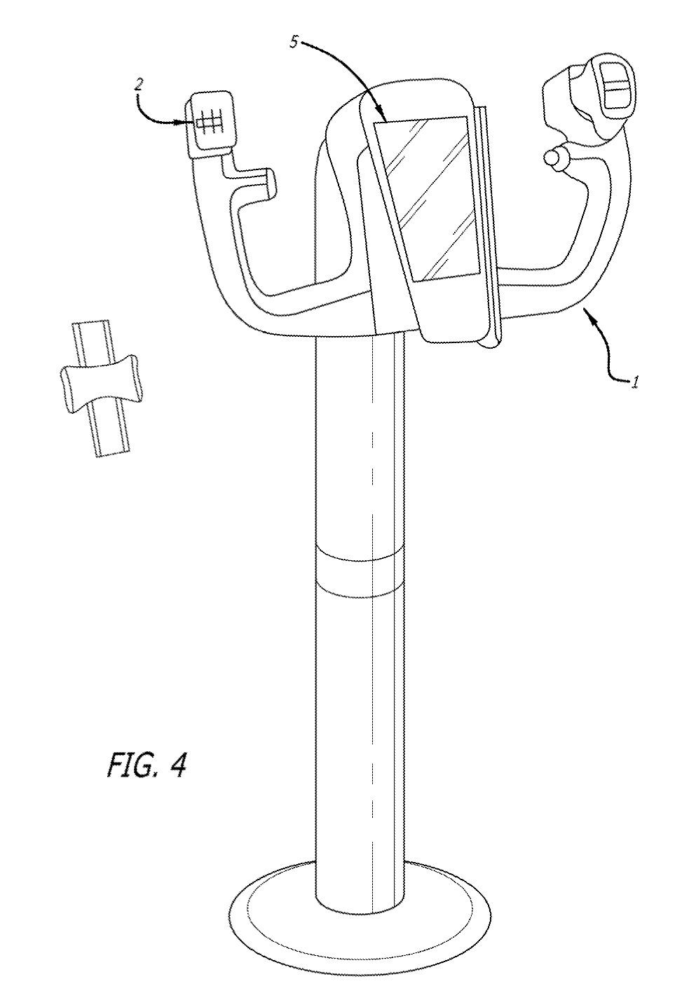

FIG. 2 illustrates a shifter knob (4) which a user can use to change speed. The shifter knob can be plugged into the STROV system. The user can choose to operate the throttle and brake control system with one hand while handling the steering wheel with the other hand. They would no longer use their finger to operate the throttle and brake control system in this embodiment.

FIG. 3 illustrates a foot operated pedal (3) for throttle and braking is shown. These petals can be plugged into the STROV and used either separately or in conjunction with hand operated controls. In this embodiment of the invention, the STROV system allows the user to use an attachable pedal and brake system that can be operated by the users' foot just like a real driving experience.

FIG. 4 illustrates the STROV airplane style handle controller designed for remote controlled airplanes and helicopters is shown. In an embodiment, this handle controller contains an attachable pedal and throttle/brake system (2,3), which can be operated by the users' foot.

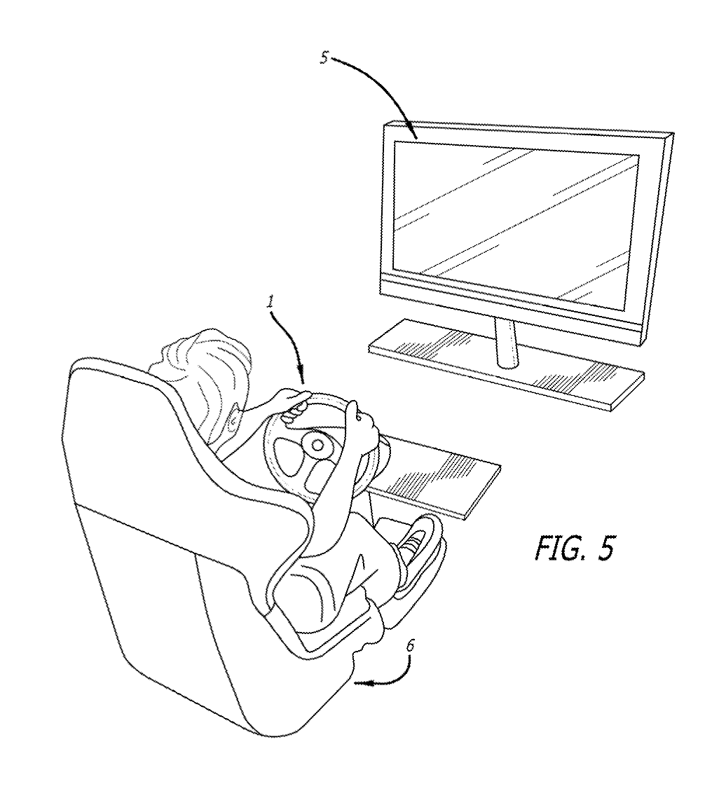

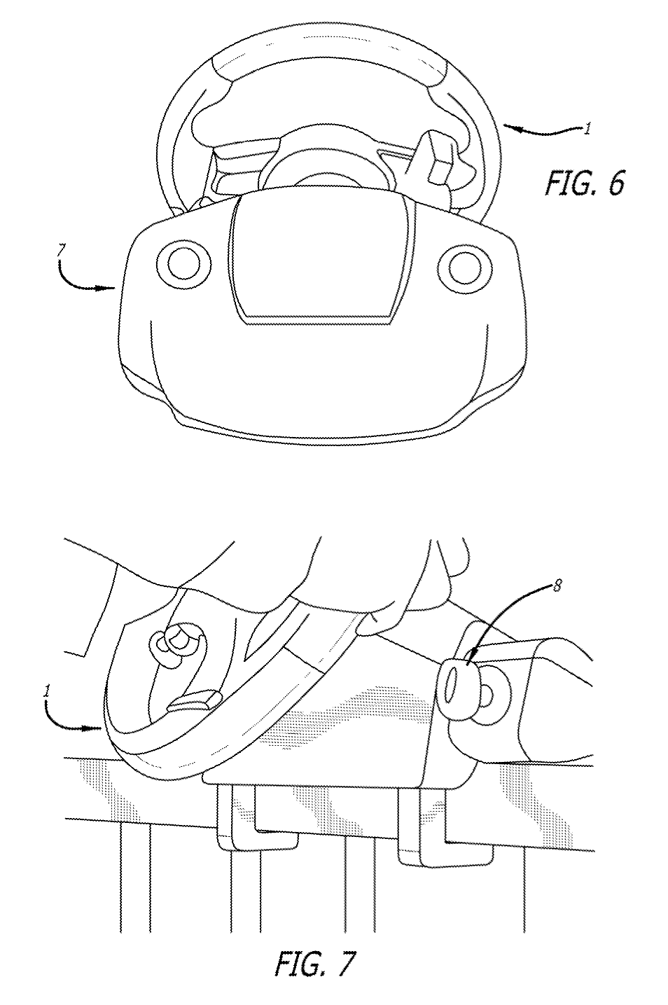

FIG. 5 illustrates a user sitting in a fixed position, such as on a chair, operating the STROV steering wheel (1) in front of a screen (5) is shown. The screen (5) overcomes the limited perspective offered by traditional systems. The vehicle can have a camera to provide feedback on the screen (5) so a driver sees the front of the vehicle on the screen (5). In one embodiment, the vehicle does not have a camera, and while in sitting position, the driver still visually follows the vehicle and relies on the screen (5) mainly for information about the vehicle.

FIG. 6 illustrates the back view of the STROV steering wheel (1) is shown.

FIG. 7 illustrates one of the ways that the STROV can be secured is shown. In this embodiment, the STROV is secured by means of two clamps. An actual key (8) for the STROC is also shown.

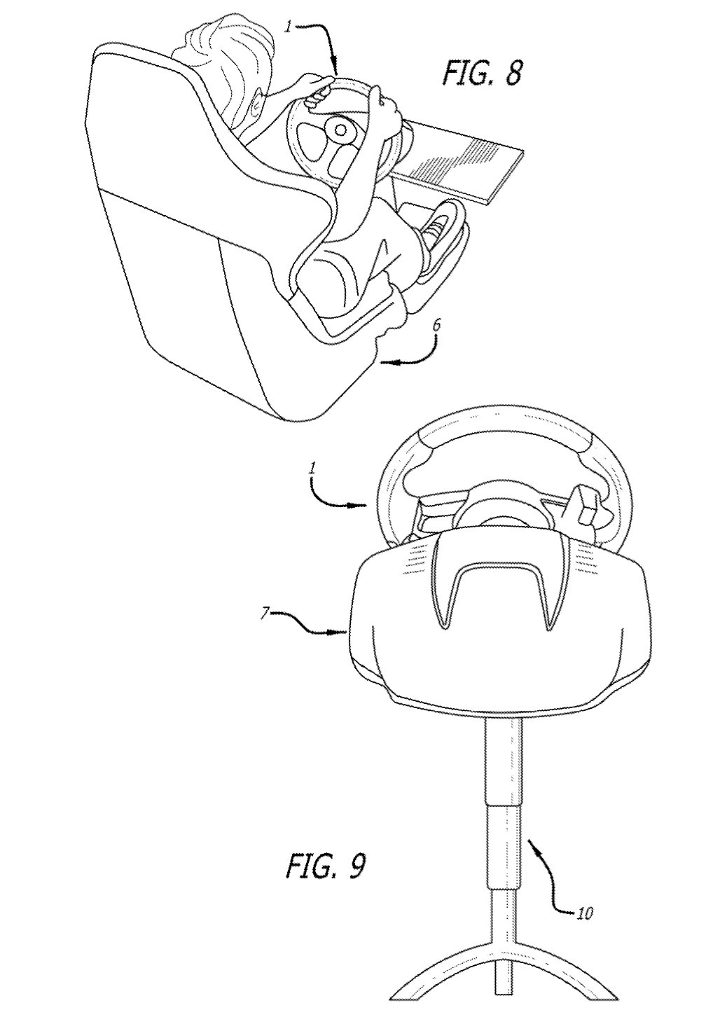

FIG. 8 illustrates a second way that the STROV can be secured is shown. In this embodiment, the STROV is secured by means of a chair (6) and a stand (10).

FIG. 9 illustrates a third way that the STROV can be secured. In this embodiment, the STROV is secured by means of a portable pole (7, 10) dropped down from the STROV itself.

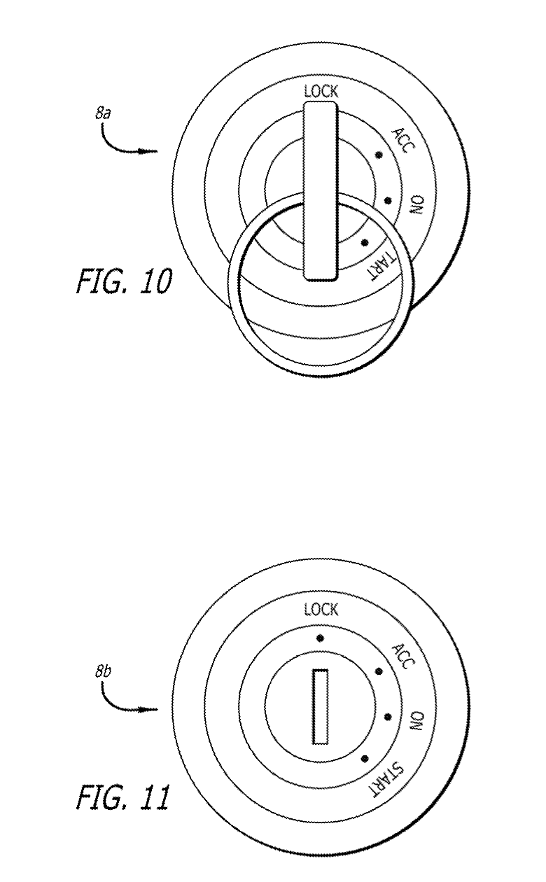

FIG. 10 illustrates the ignition key switch (8a) with a key in place is shown. The ignition switch can be part of the STROV.

FIG. 11 illustrates the ignition key switch (8b) with no key in place is shown.

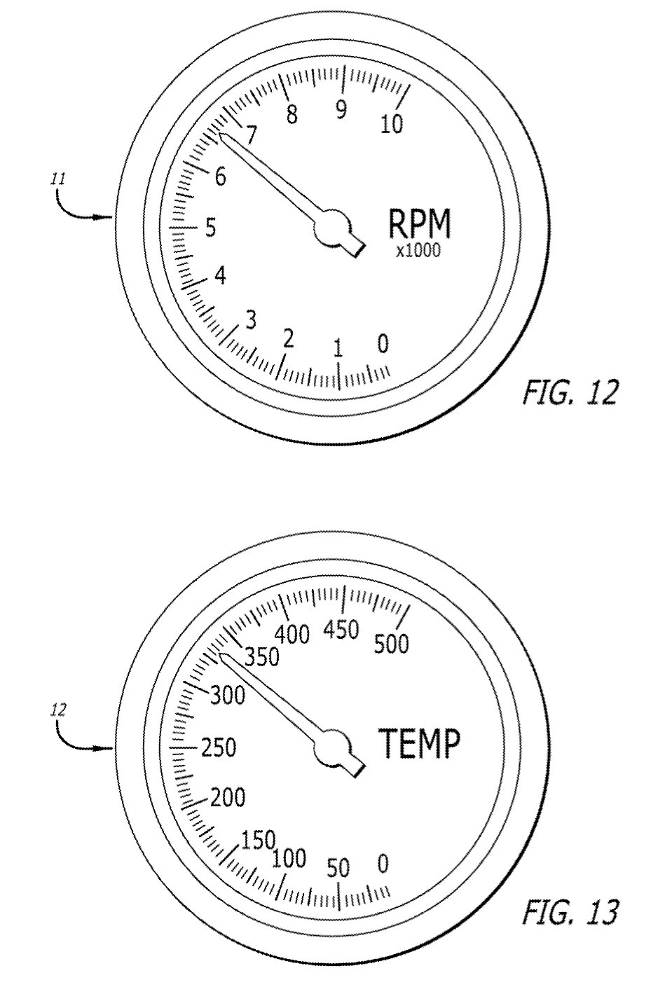

FIG. 12 illustrates the engine RPM gauge (11) with warning indicator is shown.

FIG. 13 illustrates the engine temperature gauge (12) with warning indicator is shown.

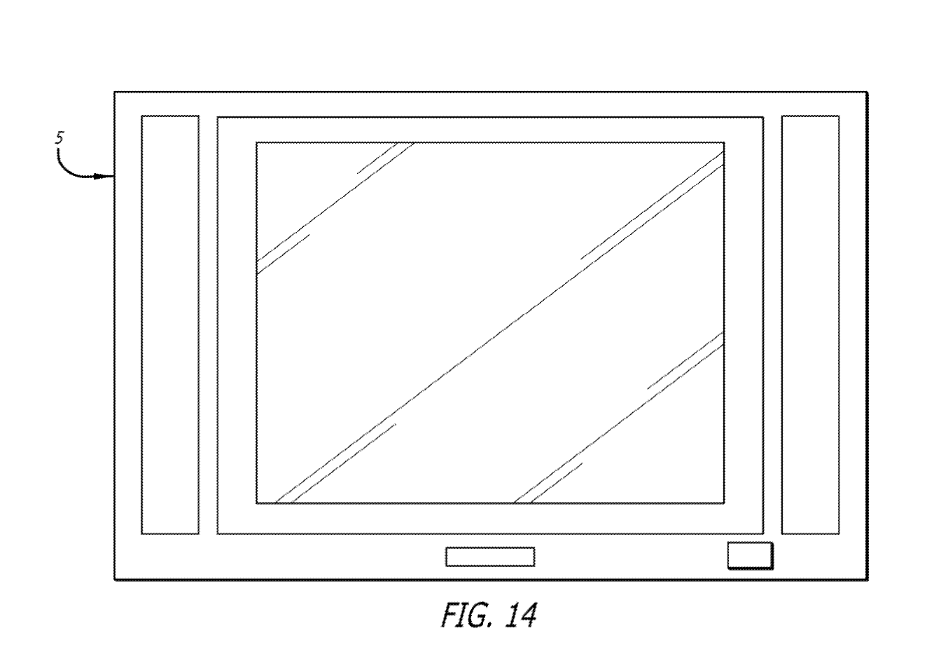

FIG. 14 illustrates the LCD or LED screen (5) for use with the STROV is shown. The screen can also have physical gauges.

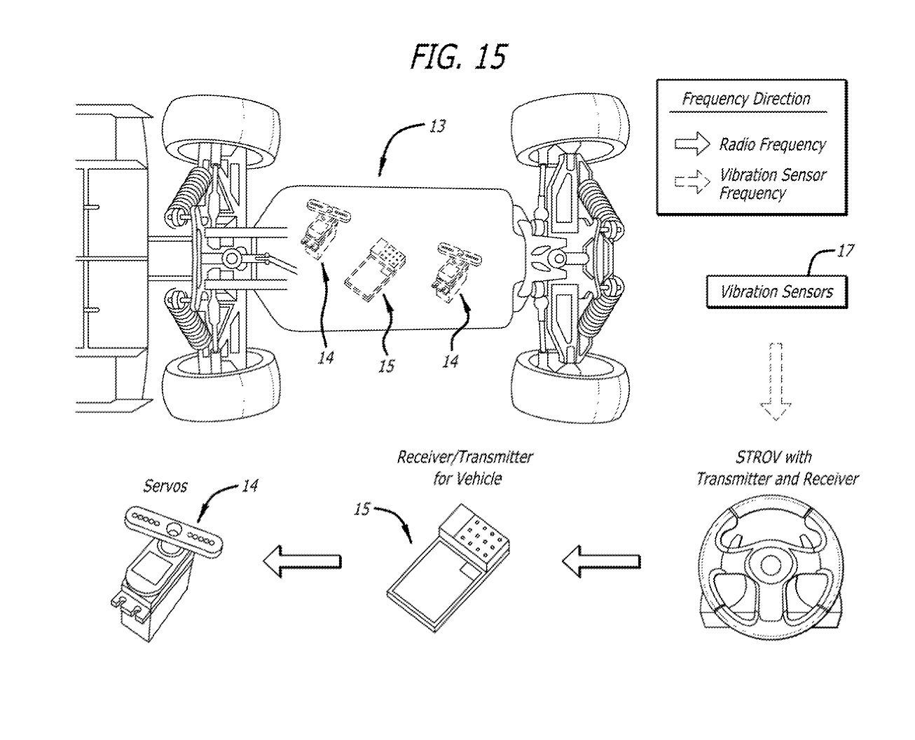

FIG. 15 illustrates the vehicle, which in is a car (13). The vehicle has a servos motor (14) for steering the vehicle. The vehicle also has a receiver/transmitter (15) that is in communication with the STROV. In one embodiment, the CPU of the receiver/transmitter (15) is used as the main CPU of the vehicle, thereby eliminating the need for another CPU.

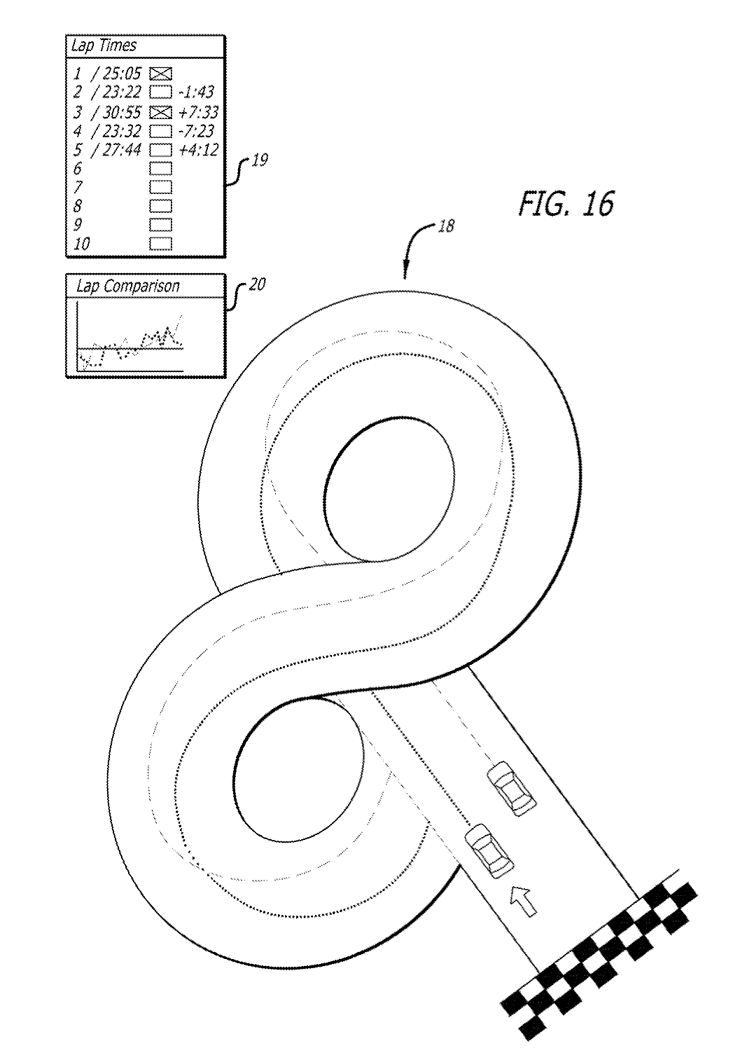

FIG. 16 illustrates a course map (18) generated by the STROV system. This course map can be displayed on the screen along with lap times (19) and lap comparison data (20).

FIG. 17 illustrates a screen that displays in real life (less than one minute delay or less, such as less than about 10 seconds) information on the vehicle. This information can include battery voltage (25), engine RPM (11), oil pressure (24), engine oil temperature (22), speed (21) or water temperature (23).

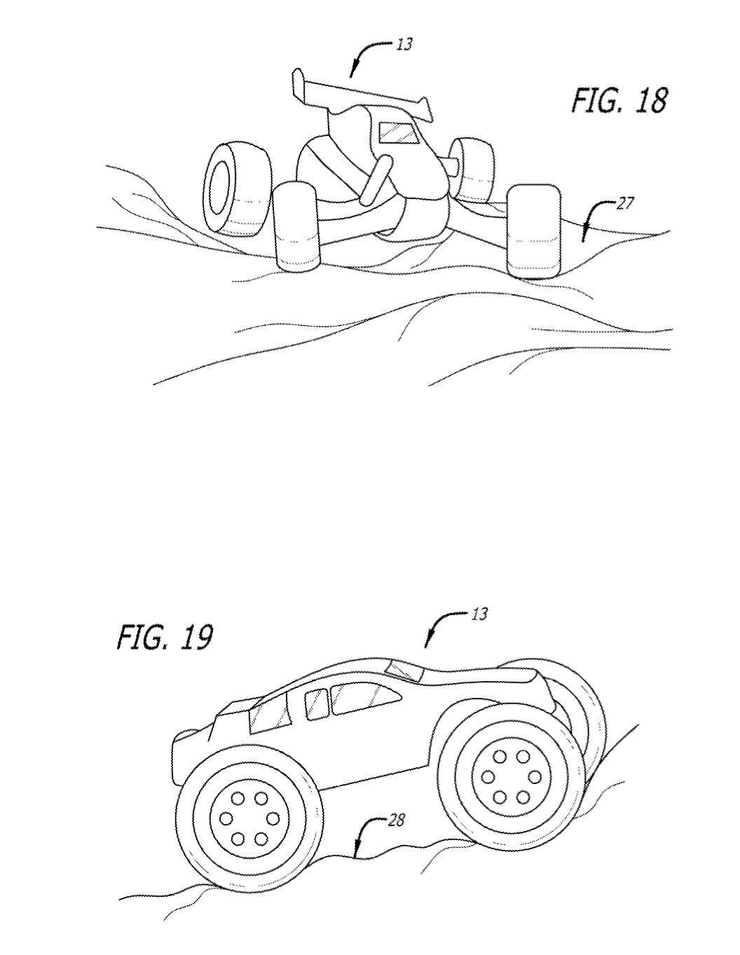

FIG. 18 illustrates a vehicle (13) travelling over uneven terrain. The vibration sensor detects the uneven ground (27) and transmits that information to the STROV. The STROV can either provide vibration feedback and/or display.

FIG. 19 illustrates a vehicle (13) travelling over bumpy terrain (28). The vibration sensor detects the uneven ground and transmits that information to the STROV. The STROV can either provide vibration feedback and/or display.

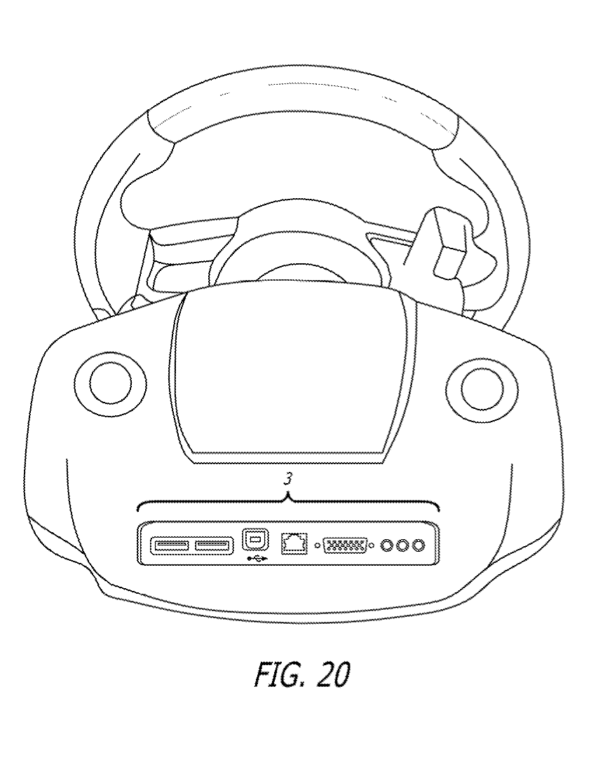

FIG. 20 illustrates a STROV with different input ports (3) to plug in various equipment, such as a screen, foot operated pedals, shifter knob, and even a steering wheel if the STROV does not have one attached. The input ports allow the attached equipment to be in electronic communication with the STROV and work with the STROV.

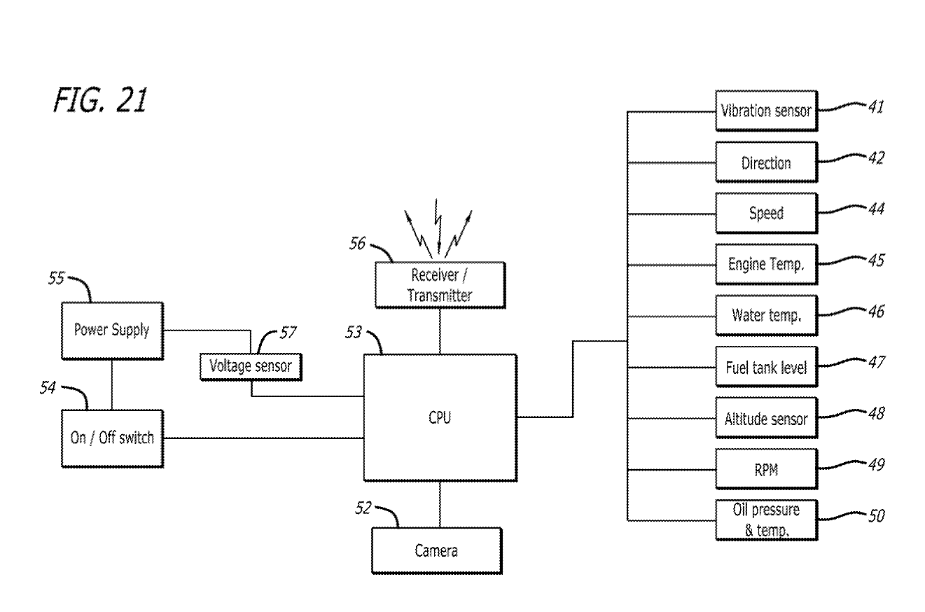

FIG. 21 illustrates one embodiment of an electronic map of a vehicle. There is a transmitter/receiver (56) for communicating with the transmitter/receiver (33) of the STROV. There is also a power supply (55). The power supply can be a battery, and there can be an electronic switch to turn on/off (54) the battery. The vehicle can have a camera (52) in front or back or the sides. The vehicle can have different peripherals that monitor the vehicle, including speed (44), engine temperature (45), water temperature (46), fuel tank level (47), altitude sensor (48), RPM (“revolutions per minute”) (49), oil pressure (50) and vibration sensor (41). The monitoring of the vehicle may depend on whether it is purely electric or uses a fuel as some of the peripherals may not be relevant or may not be used. It can also monitor the direction in which the vehicle travels through the action of the servos motor. The CPU (34) of the transmitter/receiver (33) unit can be used as the main CPU (53) of the vehicle.

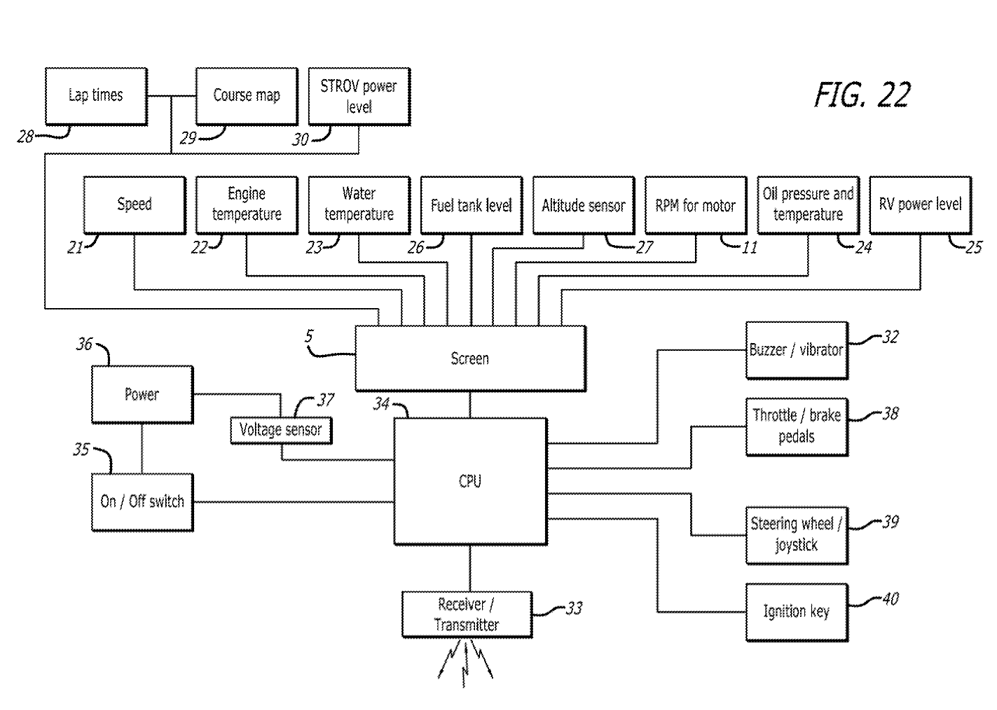

FIG. 22 illustrates the electronic map of the STROV. The STROV has a receiver /transmitter (33) in communication with the vehicle. There is a power supply (36) that can be battery or direct source connected. The STROV can have an on/off switch (35). The battery can have a voltage sensor (37). The STROV can have a buzzer/vibrator (32), throttle/brake (38), steering wheel/joystick (39), and ignition key (40). Information displayed on the screen can include, depending on the type of vehicle, can include speed (21), engine temperature (22), water temperature (23), fuel tank level (26), altitude sensor (27), RPM for motor (11), oil pressure and/or temperature (24), vehicle power level (25), lap times (28), course map (29) and STROV power level (30). The STROV can have a CPU (34) to process all the different information for display on a screen (5).

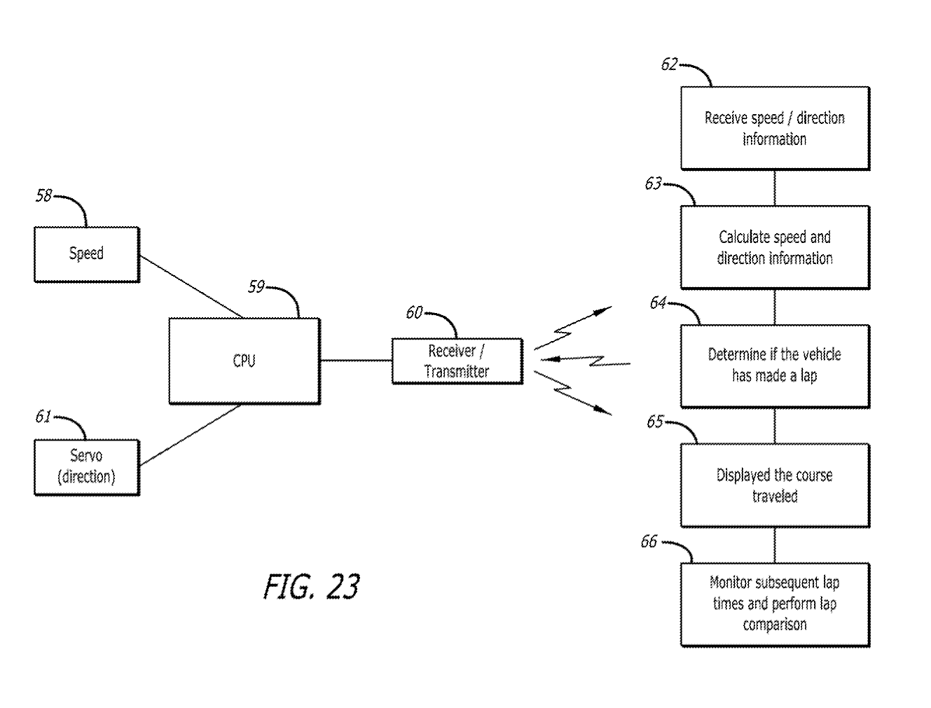

FIG. 23 illustrates the interaction between the vehicle and the STROV to map a course for the vehicle. The vehicle transmits speed (58) and direction (61) information to the STROV. The STROV received this information and calculates from the speed and direction information the course the vehicle has traveled. The course is then displayed on the screen and compared to subsequent laps on the same course.

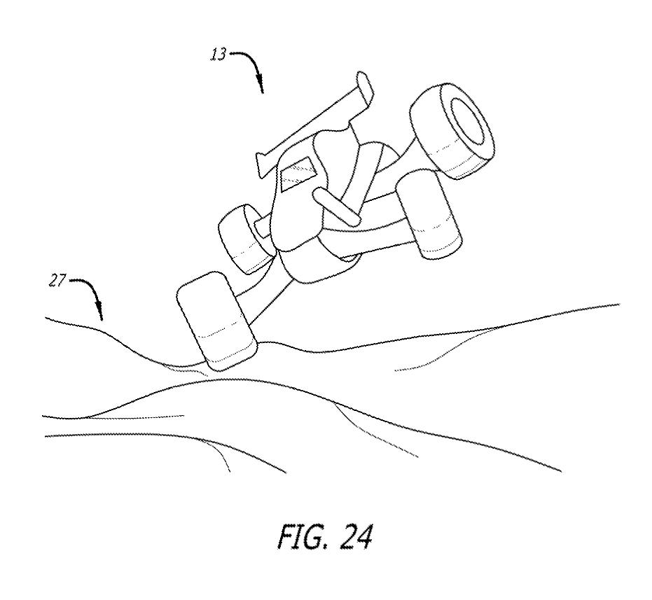

FIG. 24 illustrates a hard landing that generates a vibration.

What is claimed is:

1. A simulation transmitter for driving a recreational vehicle that simulates driving of a non-recreational vehicle, comprising:
a) a first transmitter and a first receiver connected to a first central processing unit adapted to exchange transmission signals with at least one remote controlled vehicle having a second transmitter and a second receiver connected to a second central processing unit, said vehicle optionally having a vibration sensor;
b) a steering mechanism;
c) a throttle or an input port for removably attaching a throttle;
d) a screen or an input port for removably attaching a screen to monitor the vehicle; and
e) an optional vibrator or an input port for removably attaching a vibrator;
wherein the simulation transmitter with the screen and the throttle through real time communication with the remote controlled vehicle provide a driving experience that simulates driving of a non-recreational vehicle that the recreational vehicle is designed after;
wherein if the vibration sensor detector and vibrator are present, a driver receives a vibration feedback depending on the movement of the vehicle.

2. The simulation transmitter of claim 1, wherein the simulation is carried out by providing realistic steering, optionally realistic throttle, optionally realistic braking, real time screen that displays information as a non-recreation vehicle would do, and vibration alerts as to provide a constant feedback on movement of the vehicle to the driver.

3. The simulation transmitter of claim 1, wherein the screen is digital LCD or LED screen.

4. The simulation transmitter of claim 1, wherein a brake engages when the driver moves the throttle control in opposite direction of acceleration.

5. The simulation transmitter of claim 1, wherein the transmitter is used in conjunction with a separate hand-operated or foot-operated throttle control that is attached through the port.

6. The simulation transmitter of claim 1, wherein the vibration sensor detects one or more of landing on less than all wheels, uneven terrain, bumpy terrain, rough terrain or bumping into another object or a structure.

7. The simulation transmitter of claim 1, wherein the screen displays in real time one or more of the following information:
a) speed;
b) on board engine temperature;
c) fuel tank level;
d) vehicle battery voltage level;
e) radio battery voltage level;
f) lap time;
g) stop watch;
h) vibration alerts;
i) altitude if the vehicle flies; and
j) altitude if the vehicle travels under water.

8. The simulation transmitter of claim 1, wherein the screen is lit for night vision with a plurality screen colors and tones

9. The simulation transmitter of claim 1, wherein the screen has physical gauges.

10. The simulation transmitter of claim 1, wherein the remote controlled vehicle has an electric engine/motor for moving the vehicle and the screen displays at least 3 or more of the following:
a) speed;
b) engine temperature;
c) battery voltage level for the vehicle;
d) simulation transmitter's battery voltage levels;
e) RPM gauge with a warning indicator;
f) lap times.

11. The simulation transmitter of claim 1, wherein the remote controlled vehicle has an engine/motor that uses fuel and the screen displays at least 3 or more of the following:
a) speed;
b) engine temperature;
c) fuel level;
d) battery voltage level for the vehicle;
e) simulation transmitter's battery voltage levels;
f) RPM gauge with a warning indicator;
g) oil pressure; and
h) water temperature.

12. The simulation transmitter of claim 1, wherein the simulation transmitter learns a to track layout, and then calculates lap time and records the driven course for each lap, and displays course map or lap times on the screen.

13. The simulation transmitter of claim 1, wherein plug and play technology is used to display and transfer video output and data via the port on a computer screen, monitor or television, resulting in the computer screen, monitor or television acting as the screen of the simulation transmitter.

14. The simulation transmitter of claim 1, wherein, the vehicle is a remote controlled vehicle is a car, truck, buggy, off-road vehicles.

15. The simulation transmitter of claim 1, wherein the vehicle is a flying airplane, helicopter, UFO or flying saucer.

16. The simulation transmitter of claim 1, wherein the vehicle is a boat, submarine, or jet ski.

17. The simulation transmitter of claim 1, wherein the vehicle has an on-board battery with sufficient capacity to allow for supplementary applications selected from the group consisting of at least one of a glow igniter charger, a battery charger, a battery balancer, and a battery discharger, and combinations thereof.

18. The simulation transmitter of claim 1, wherein the driver sits in a fixed position to operate the remote controlled vehicle in front of a screen.

19. The simulation transmitter of claim 1, wherein an ignition with a real key is utilized.

20. A remote controlled vehicle system for driving a recreational vehicle that simulates driving of a non-recreational vehicle, comprising:
a) at least one remote controlled vehicle with a transmitter and a receiver connected to a central processing unit, said vehicle optionally having a vibration sensor;
b) a simulation transmitter having:
(i) a transmitter and a receiver connected to a central processing unit adapted to exchange transmission signals with the remote controlled vehicle;
(ii) a steering mechanism or a port for removably attaching said mechanism;
(iii) a throttle or a port for removably attaching a throttle;
(iv) a digital screen or a port for removably attaching a digital screen to monitor the vehicle; and
(v) an optional vibrator or a port for removably attaching a vibrator;
wherein the simulation transmitter with the screen and the throttle through real time communication with the remote controlled vehicle provide a driving experience that simulates driving of a non-recreational vehicle that the recreational vehicle is designed after;
wherein if the vibration sensor detector and vibrator are present, a driver receives a vibration feedback depending on the movement of the vehicle.
